(19) United States
(12) Patent Application Publication
(10) Pub. No.: US 2006/0275634 A1
(43) Pub. Date: Dec. 7, 2006

(54) METHOD FOR CONTROLLING OUTPUT POWER OF FUEL CELL

(76) Inventors: Feng-Yi Deng, Taipei (TW); Yu-Chin Wang, Taipei (TW); Yu-Lin Tang, Taipei (TW)

Correspondence Address: G. LINK CO., LTD, 3550 BELL ROAD, MINOOKA, IL, 60447, US

(21) Appl. No.: 11/421,891

(22) Filed: Jun. 2, 2006

(30) Foreign Application Priority Data
Jun. 6, 2005 (TW) 094118643

(51) Int. Cl. H01M 8/04

(52) U.S. Cl. 429/13; 429/23

(57) ABSTRACT

A method for controlling an output power of a fuel cell is disclosed. A DC converter and a fuel cell are provided, and a voltage input end of the DC converter is connected to a voltage output end of the fuel cell. The DC converter is used to convert an input voltage of the fuel cell into a regular output voltage. The DC converter is also used to retain a voltage of the voltage input end of the DC converter within a predetermined range, and thereby an output voltage of the fuel cell is maintained within the predetermined range. The predetermined range of the voltage is set according to a number of membrane electrode assemblies in the fuel cell and a voltage of the membrane electrode assemblies generated in an extent of optimal power.

### FIELD OF THE INVENTION

The present invention relates to a method for controlling the output power of a fuel cell, and more particularly, to a method of utilizing a DC converter to control over the voltage from an input of the DC converter so that the voltage is retained within a predetermined range. Accordingly, the fuel cell continues performing on the condition of optimal output power.

### BACKGROUND OF THE INVENTION

Conventionally, it merely takes the stability of output voltage into consideration when designing a DC converter, such as a DC converter for a secondary cell, without worrying about the effect of power input from the secondary cell on the DC converter. The secondary cell belongs to a kind of energy container, which stores power after charged and releases power when discharged. In addition, the voltage output by the secondary cell keeps constant if the power of the secondary cell is sufficient when discharging the secondary cell and the DC converter will receive wobbly input voltage. On the contrary, the fuel cell belongs to a kind of energy converter, which can not store power in advance. While the fuel cell is cooperated with a traditional DC converter, the voltage generated by the fuel cell varies dramatically due to external loadings. Then, the DC converter utilizes the changed input voltage to convert power. As a result, the fuel cell may not perform in an optimal status even though the DC converter still produces a regular output voltage.

In view of the disadvantage that traditional DC converter does not provide optimal power for the fuel cell, a method for controlling the output power of a fuel cell is needed, by which the fuel cell continues operating on the condition of optimal power.

### SUMMARY OF THE INVENTION

It is a primary object of the invention to provide a method for controlling an output power of a fuel cell, by which the DC converter retains the output voltage within a regular range, and the fuel cell continues operating with optimal output power as well.

In accordance with the aforesaid object of the invention, a method for controlling an output power of a fuel cell is provided, which comprises the following steps. A DC converter and a fuel cell are provided, and a voltage input end of the DC converter is connected to a voltage output end of the fuel cell. The DC converter is used to convert an input voltage of the fuel cell into a regular output voltage. The DC converter is also used to retain a voltage of the input end of the DC converter within a predetermined range, and the predetermined range of the voltage is set according to the number of membrane electrode assemblies in the fuel cell and a voltage of the membrane electrode assemblies (MEAs) generated in an extent of optimal power

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a flow chart of controlling the output power of a fuel cell according to an embodiment of the invention;

FIG. 2 shows a graph of voltage-power for a single membrane electrode assembly in a fuel cell controlled by the method of the invention;

FIG. 3 is a diagram showing that a DC converter controlled by the method in accordance with an embodiment of the invention is connected to a fuel cell and loadings; and

FIG. 4 illustrates a circuit in accordance with the embodiment of FIG. 3.

### DETAILED DESCRIPTION OF THE INVENTION

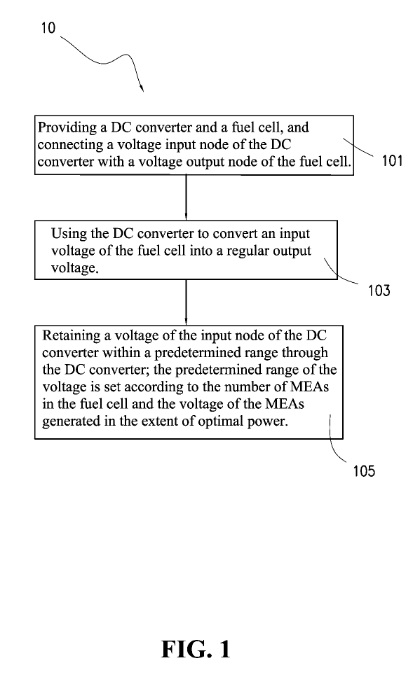

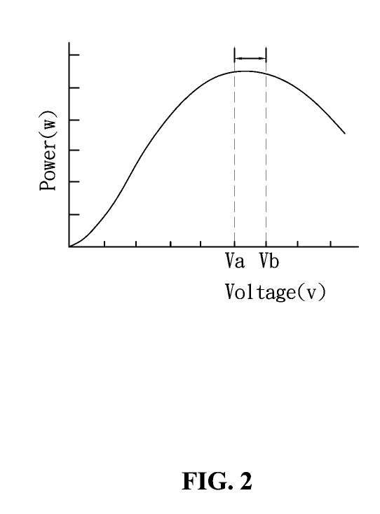

FIG. 1 is a flow chart of controlling the output power of a fuel cell according to an embodiment of the invention. FIG. 2 shows a graph of voltage-power for a single membrane electrode assembly (MEA) in a fuel cell controlled by the method of the invention. It is known that the fuel cell 20 belongs to a kind of energy converter, which does not store power in advance, and the traditional DC converter is designed to output regular voltage without thinking of the characteristic of input voltage. As a fuel cell 20 is cooperated with a traditional DC converter, the output voltage of the operated fuel cell 20 varies dramatically due to external loadings. Referring to FIG. 2, which shows the characteristic of the fuel cell 20, if the output voltage of each MEA in the operated fuel cell 20 does not reach between VA and VB, then the fuel cell 20 does not perform on the conditional of optimal power. A DC converter 30 controlled by the method 10 provides regular output voltage for loadings, and retains the input voltage within a predetermined range. Thereby, the output voltage of each MEA in the operated fuel cell 20 is within VA and VB, and the fuel cell 20 performs on the conditional of optimal power.

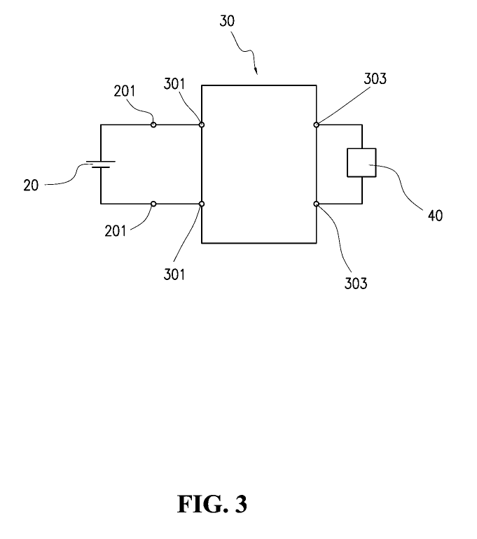

The method 10 includes a step 101, a step 103 and a step 105, which is separately described hereinafter. The step 101 is used to provide a DC converter 30 and a fuel cell 20 and to connect a voltage input end 301 of the DC converter 30 with a voltage output end 201 of the fuel cell 20. FIG. 3 is a diagram showing that a DC converter controlled by the method in accordance with an embodiment of the invention is connected to a fuel cell and loadings. The fuel cell 20 includes a plurality of MEAs to perform electrochemical reactions and generate power, and outputs a voltage at the voltage output end 201. The voltage input end 301 of the DC converter 30 is electrically coupled to the voltage output end 201.

In the step 103, the DC converter 30 converts an input voltage from the fuel cell 20 into a regular output voltage. The DC converter 30 transforms power of the fuel cell 20 into a regular voltage such as 5 volts (V) by means of circuits, and outputs the regular voltage for the loading 40 through a voltage output end 303. Based on the requirements of loadings, the DC converter 30 may output different regular voltages, such as 5V or 12V. The regular voltage output by the DC converter 30 is not limited to a specific value.

In the step 105, the DC converter 30 maintains the voltage at the input end 301 of the DC converter 30 within a predetermined range. That is, the DC converter 30 retains the voltage of the output end 201 of the fuel cell 20 within the predetermined range. The determined range of the regular voltage is set according to the number of MEAs in the fuel cell 20 and the voltage of the MEAs generated in the extent of optimal power. It is one of the most important features of the method 10 that the voltage at the input end 301 of the DC converter 30 is retained within a predetermined range, with which the fuel cell 20 is operated in the extent of optimal power.

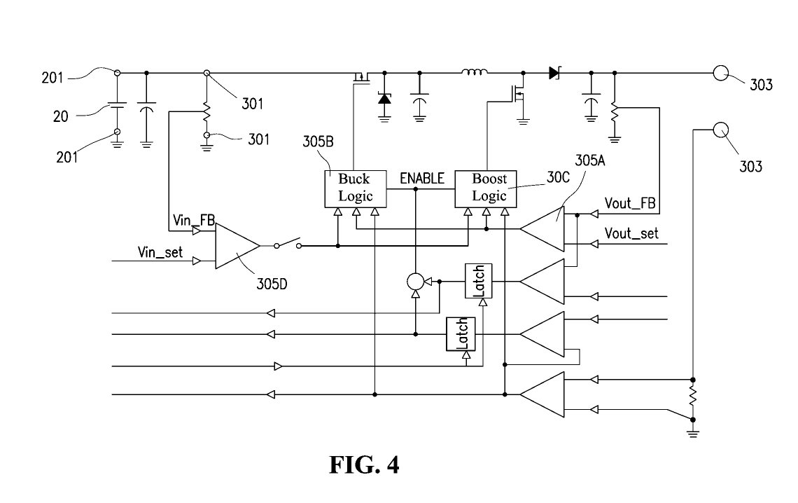

FIG. 4 illustrates a circuit in accordance with the embodiment of FIG. 3. As shown in FIG. 4, the operations of buck logic 305B and boost logic 305C are controlled through the feedback of signal Vout_FB and the input setting of signal Vout_set processed by an operational amplifier 305A, and also through the input of signals Vin_FB and Vin_set processed by the operational amplifier 305D. By controlling the operations of buck logic 305B and boost logic 305C, the voltage at the input end 301 is adjusted to suit with the predetermined range in the step 105.

According to the embodiment of the present invention, the fuel cell 20 could be a direct methanol fuel cell (DMFC), and the DMFC 20 includes N MEAs, the predetermined range described in the step 105 is set between 0.3V×N and 0.4V×N. For the present processes for manufacturing MEAs of the DMFC 20, the voltage of a single MEA for producing optimal power is between 0.3V and 0.4V.

Furthermore, in another preferred embodiment, the fuel cell 20 could be a proton exchange membrane fuel cell (PEMFC), and the PEMFC 20 includes N MEAs, the predetermined range described in the step 105 is set between 0.5V×N and 0.6V×N. For the present processes of manufacturing MEAs in the PEMFC 20, the voltage of a single MEA for producing optimal power is between 0.5V and 0.6V.

As has been described above, according to the present invention, the method not only retains the output voltage within a regular range, but also continues operating the fuel cell with optimal output power.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for controlling an output power of a fuel cell, comprising the steps:
providing a DC converter and a fuel cell, and connecting a voltage input end of the DC converter with a voltage output end of the fuel cell;
converting an input voltage of the fuel cell into a regular output voltage using the DC converter; and
retaining a voltage of the voltage input end of the DC converter within a predetermined range using the DC converter, wherein the predetermined range of the voltage is set based on a number of membrane electrode assemblies(MEAs) in the fuel cell and a voltage of the MEAs generated in an extent of optimal power, and thereby an output voltage of the fuel cell is maintained within the predetermined range of the voltage.

2. The method of claim 1, wherein the MEA is a MEA in a direct methanol fuel cell (DMFC), and the voltage of single MEA is between 0.3 volts and 0.4 volts.

3. The method of claim 2, wherein the DMFC includes N MEAs, and the predetermined range of the voltage is between 0.3V×N and 0.4V×N.

4. The method of claim 1, wherein the MEA is a MEA of a proton exchange membrane fuel cell (PEMFC), and the voltage of a single MEA is between 0.5 volts and 0.6 volts.

5. The method of claim 4, wherein the PEMFC includes N MEAs, and the predetermined range of the voltage is between 0.5V×N and 0.6V×N.

6. The method of claim 1, wherein the voltage of the MEAs generated in the extent of optimal power is between VA and VB.

7. The method of claim 6, wherein the number of the MEAs is N, and the predetermined range of the voltage is between VA×N and VB×N.

8. The method of claim 1, wherein the fuel cell is a fuel cell fabricated by a printed circuit board process.
